(19) United States
(12) Patent Application Publication
(10) Pub. No.: US 2026/0349078 A1
(43) Pub. Date: Nov. 5, 2026

(54) MODULAR LIDAR SYSTEM AND RELATED METHODS

(71) Applicant: 9459-6467 QUEBEC INC., Quebec (CA)

(72) Inventors: Jeremy JUNG, Quebec (CA); Maude PELLETIER, Quebec (CA); Andreas KLEIN, Quebec (CA)

(21) Appl. No.: 19/488,982

(22) PCT Filed: May 31, 2024
(86) PCT No.: PCT/CA2024/050736

§ 371 Date: Dec. 1, 2025

Related U.S. Application Data
(60) Provisional application No. 63/505,562, filed on Jun. 1, 2023.

(51) Int. Cl. G01S 7/481

(52) U.S. Cl. CPC G01S 7/4813

(57) ABSTRACT

There is provided a modular LIDAR system including a plurality of modules and a two-level locking mechanism configured to engage two subsequent modules of the modules. The two-level locking mechanism includes a first level configured to align the two subsequent modules, the first level including sockets provided in one of the two modules and curved arms outwardly extending from another one of the two subsequent module, and a second level configured to lock the two subsequent modules together, the second level including slots provided in one of the two subsequent modules and lever arms, each lever arm having a respective end outwardly extending from another one of the two subsequent module, wherein each lever arm is adapted to be inserted in a corresponding slot.

### TECHNICAL FIELD

The technical field generally relates to the field of light detection and ranging (LIDAR) technologies, and more particularly relates to LIDAR systems and related methods for geomatics applications.

### BACKGROUND

Commercially available systems and/or methods for producing maps present several drawbacks and limitations, notably in terms of range of operation. It has been observed that most common approaches rely on the use of several LIDAR systems and/or additional devices to adequately map a terrain, which is notably associated with economic and efficiency challenges. Other recent approaches have also been developed to provide LIDAR systems with modularity. However, these approaches tend to be limited, not only because their relatively young history, but also because several design challenges still have to be addressed.

There is still a need for techniques, apparatuses, devices, and methods that alleviate or mitigate the problems of prior art.

### SUMMARY

The present techniques generally relate to a modular LIDAR system for geomatics applications, as well as related methods.

In accordance with one aspect, there is provided a modular LIDAR system including a plurality of modules and a two-level locking mechanism. The two-level locking mechanism is configured to mechanically engage two subsequent modules of said plurality of modules. The two-level locking mechanism includes a first level configured to align the two subsequent modules, the first level including a pair of sockets provided in one of the two subsequent modules and a pair of curved arms outwardly extending from another one of the two subsequent module, wherein each curved arm is adapted to be inserted in a respective socket upon a relative rotational movement between the two subsequent modules. The two-level locking mechanism includes a second level configured to lock the two subsequent modules together. The second level includes a pair of slots provided in one of the two subsequent modules and a pair of lever arms, each lever arm having a respective end outwardly extending from another one of the two subsequent module, wherein each lever arm is adapted to be inserted in a corresponding slot and lock the two subsequent modules together when a rotational movement is imparted to each lever arm.

In some embodiments, said plurality of exchangeable modules includes a main module, a LIDAR sensor, a photogrammetry camera, an inertial sensor module (IMU), a global positioning system (GPS), a processing unit, a data collection module, an external battery, an internal battery, a camera and/or a power supply.

In accordance with one aspect, there is provided a modular LIDAR system, including: a plurality of modules; and a two-level locking mechanism configured to mechanically engage two subsequent modules of said plurality of modules, the two-level locking mechanism including: a first level configured to align the two subsequent modules, the first level including: a pair of sockets provided in one of the two subsequent modules; and a pair of curved arms outwardly extending from another one of the two subsequent module, wherein each curved arm is adapted to be inserted in a respective socket upon a relative rotational movement between the two subsequent modules; and a second level configured to lock the two subsequent modules together, the second level including: a pair of slots provided in one of the two subsequent modules; and a pair of lever arms, each lever arm having a respective end outwardly extending from another one of the two subsequent module, wherein each lever arm is adapted to be inserted in a corresponding slot and lock the two subsequent modules together when a rotational movement is imparted to each lever arm.

In some embodiments, said plurality of exchangeable modules includes a main module, a LIDAR sensor, a photogrammetry camera, an inertial sensor module (IMU), a global positioning system (GPS), a processing unit, a data collection module, an external battery, an internal battery, a camera and/or a power supply.

In some embodiments, said plurality of modules is configured to be replaced or exchanged without recalibrating the modular LIDAR system.

In some embodiments, said plurality of modules has standardized dimensions.

In some embodiments, the modular LIDAR system includes a cover.

In some embodiments, the cover is made of rubber.

In some embodiments, at least one of said plurality of modules is a processing module including a processor configured to: automatically determine which modules are present on the modular LIDAR system; and automatically select or adapt the operation settings of each module.

In some embodiments, the operation settings are obtained from a calibration database.

In some embodiments, the calibration database is stored on a server.

In some embodiments, the calibration database is stored in the cloud.

In some embodiments, each one of the pair of curved arms has an arm profile defining an arm circle arc.

In some embodiments, the inner arm circle arc includes a starting point and an ending point, separated by an angle of about 90°.

In some embodiments, each one of the pair of sockets has a socket profile defining a socket circle arc.

In some embodiments, the socket circle arc includes a starting point and an ending point, separated by an angle of about 90°.

In some embodiments, each one of the pair of lever arms includes a proximal end and a distal end, the distal end including a hook-shaped portion adapted to be inserted the corresponding slot.

In some embodiments, the modular LIDAR system includes a top portion and a bottom portion, the two-level locking mechanism being provided in the bottom portion, the top portion including a second pair of slots provided in one of the two subsequent modules and a second pair of lever arms, each having a respective end outwardly extending from another one of the two subsequent module, the second pair of lever arms is adapted to be inserted in the second pair of slot sand lock the two subsequent modules together when a rotational movement is imparted to the second pair of lever arms.

Other features and advantages of the present description will become more apparent upon reading of the following non-restrictive description of specific embodiments thereof, given by way of example only with reference to the accompanying drawings.

### BRIEF DESCRIPTION OF THE DRAWINGS

FIGS. 1 to 8 illustrate various aspects, features, and implementations of, or related to, the present techniques.

### DETAILED DESCRIPTION

In the following description, similar features in the drawings have been given similar reference numerals, and, to not unduly encumber the figures, some elements may not be indicated on some figures if they were already identified in one or more preceding figures. It should also be understood herein that the elements of the drawings are not necessarily depicted to scale, since emphasis is placed upon clearly illustrating the elements and structures of the present embodiments. The terms “a”, “an” and “one” are defined herein to mean “at least one”, that is, these terms do not exclude a plural number of elements, unless stated otherwise. It should also be noted that terms such as “substantially”, “generally” and “about”, that modify a value, condition, or characteristic of a feature of an exemplary embodiment, should be understood to mean that the value, condition or characteristic is defined within tolerances that are acceptable for the proper operation of this exemplary embodiment for its intended application.

In the present description, the terms “connected”, “coupled”, and variants and derivatives thereof, refer to any connection or coupling, either direct or indirect, between two or more elements. The connection or coupling between the elements may be acoustical, mechanical, physical, optical, operational, electrical, wireless, or a combination thereof.

It will be appreciated that positional descriptors indicating the position or orientation of one element with respect to another element are used herein for ease and clarity of description and should, unless otherwise indicated, be taken in the context of the Figures and should not be considered limiting. It will be understood that spatially relative terms (e.g., “outer” and “inner”, “outside” and “inside”, “periphery” and “central”, “top” and “bottom”, and “left” and “right”) are intended to encompass different positions and orientations in use or operation of the present embodiments, in addition to the positions and orientations exemplified in the figures.

In the context of this disclosure, the expression “sample” refers to any items or locations that can be investigated, characterized, or mapped, such as geographic terrains, bodies of water (e.g., oceans), surfaces (flat and/or curved surfaces), parts, components, structures, materials, and any combinations thereof. More specifically, the techniques, including systems and methods, that will be herein described can be used to characterize such samples. Of note, the expression “sample” may sometimes be referred to as “target”.

The description generally relates to systems and devices for terrain mapping, unmanned aerial vehicle terrain scanning, 3D mapping, photogrammetry and similar applications. More particularly, the present description relates to light detection and ranging (LIDAR) technologies used in the context of producing high-resolution maps or similar representations, which may, in some embodiments, be visual representations of acquired data. It should be noted that the LIDAR technologies that will be herein described may have terrestrial applications, extraterrestrial applications (e.g., on another planet), airborne applications and/or mobile applications. The expressions “LIDAR”, “LiDAR” or “LADAR” encompass techniques for determining ranges using light. The determination of the ranges is based on targeting a sample or a target with an optical source, such as a laser, and measuring the time required for the light generated by the laser to return to the LIDAR sensor (or a component thereof, such as the receiver), after being reflected by the targeted sample or target. The technology and its advantages will become more apparent from the detailed description and examples that follow, which describe the various embodiments of the technology.

The present technology concerns a modular LIDAR system including a plurality of exchangeable and replaceable modules (sometimes referred to as “components”). The modularity provides the LIDAR system with a wider range of operation in comparison with existing solutions, as the modules (e.g., LIDAR sensor) of the system can be replaced, depending on the targeted application and/or specific requirements that may be associated with the targeted application (e.g., range of operation, precision, and many others).

The following table illustrates a mapping between the components of the system that will be herein described and reference numbers:

| Reference Number | Component |
|---|---|
| 10 | Modular LIDAR system |
| 12A, B | Modules |
| 14 | Two-level locking mechanism |
| 16A, B | Sockets |
| 18A, B | Curved arms |
| 20A, B | Slots |
| 22A, B | Lever arms |

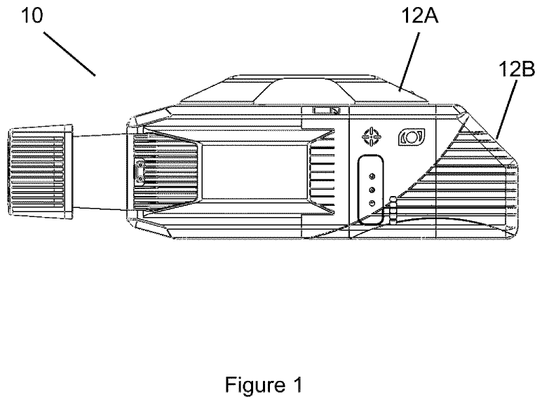

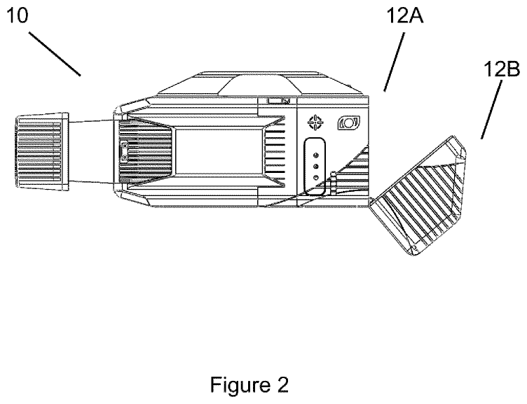

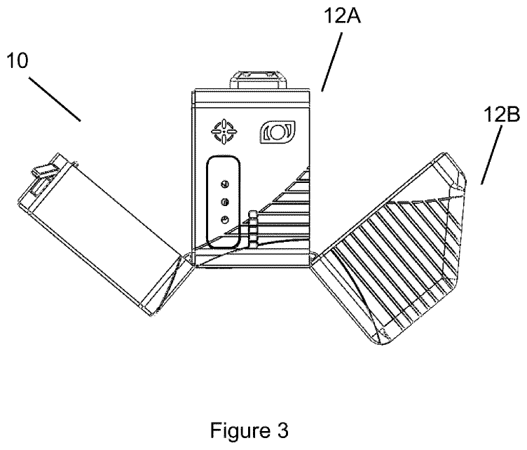

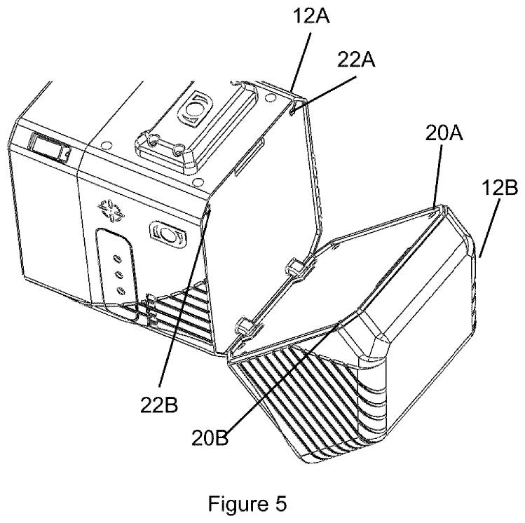

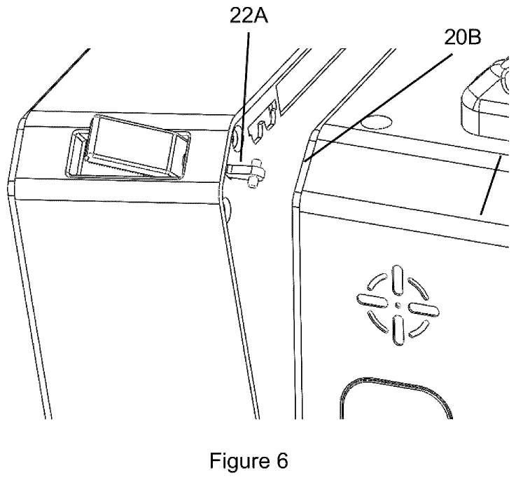

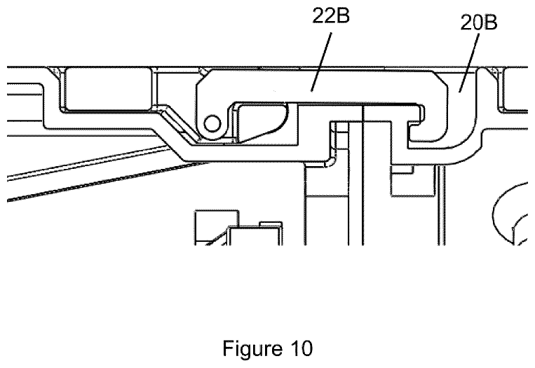

Now turning to FIGS. 1 to 8, there is illustrated a modular LIDAR system, in accordance with one embodiment. FIG. 1 illustrates a modular LIDAR system in an assembled configuration, i.e., the modular LIDAR system includes a plurality of modules all assembled and locked together. FIGS. 2 and 3 each illustrate the modular LIDAR system of FIG. 1 in an unassembled configuration. As it can be seen, the plurality of modules forming the modular LIDAR can be unattached or unmounted from each other. As can be seen in these Figures, the shown embodiments of the modular LIDAR system include several modules, such as, for example, and without being limitative, a LIDAR sensor, a photogrammetry camera, an inertial sensor module, an inertial measuring unit (IMU), a global positioning system (GPS), processing units, a data collection module, a battery module, a camera panel, a camera, a power supply, a support module and many others. Other processing modules and/or module(s) relying on artificial intelligence may also be used, in order to facilitate, accelerate or enhance the treatment of acquired data. The modules can be selectively attached (or mounted) one to another and detached (or unmounted) one from another, using a locking mechanism that will be described in greater details hereinbelow.

The LIDAR sensor is generally selected according to determined, predetermined, specific or custom scanning requirements imposed or dictated by the targeted application, such as, for example and without being limitative, accuracy, range, scan speed, measuring rate, or other relevant parameters for a given task or project, which may be influenced by a plurality of factors, including environmental conditions and other non-environmental events. The limitations of existing technologies are often associated with the LIDAR sensor, because of the relatively small window (or operational range) wherein it can be used, which may limit their implementations, given the results that they are able to produce or output. The present technology allows changing a given LIDAR sensor module having a first range of operation with another LIDAR sensor module having a second range of operation, the second range being different than the first. Of note, the range may differ one from another in terms of lower limit and/or upper limit. The present technology also allows replacing any other modules of the modular LIDAR system, including the ones having been listed above. It should be noted that the modular LIDAR system is designed such that no additional hardware modification is required when a module (e.g., the LIDAR sensor module) is changed (i.e., mounted or unmounted), meaning that all the modules are ready to use once assembled. In some embodiments, each module may be provided with plug-in connectors to facilitate their operational coupling, for example for facilitating the transmission of power, current, voltage and/or data between the modules.

The data collection module may include one or more processing units (sometimes referred to as “processor(s)”). The processing unit(s) can be configured to automatically identify or detect which modules are mounted in the modular LIDAR system, and similarly, automatically identify which modules have been removed from the modular LIDAR system. After the identification of the modules being mounted in the modular LIDAR system, the processing unit(s) may automatically select the corresponding operation settings for each one of the modules. The different operation settings may either be stored on a memory provided on the modular lidar system or obtained from a calibration database, which may be stored on a server, a physical memory, or in the cloud. As it will be readily understood, the processing unit may be implemented as a single unit or as a plurality of interconnected processing sub-units. Also, the processing unit may be embodied by a computer, smartphone, a microprocessor, a microcontroller, a central processing unit, or by any other type of processing resource, or any combination of such processing resources configured to operate collectively as a processor or a processing unit. The processor may be implemented in hardware, software, firmware, or any combination thereof, and be connected to the components of the modular LIDAR system via appropriate communication ports.

It should be noted that the modules can be relatively easily and seamlessly exchanged (i.e., removed and replaced by another module) to build a system that meets predetermined specifications or operates in a given range of operation. The modular LIDAR system can be assembled and disassembled in real time or near real time on site, which allows using different LIDAR sensor modules when mapping a location without relying on several distinct systems. The modules can also be replaced or exchanged without recalibrating the whole modular LIDAR system. The design of the modular LIDAR system is such that the system is portable and relatively easy to carry.

In some embodiments, each module may be constructed with or may have standardized dimensions, i.e., the dimensions of all the modules may be substantially the same, which may provide the modular LIDAR system with greater flexibility, adaptability, and variety in use. The standardized dimensions of the modules may also facilitate their relative alignment, as it will be explained in greater detail below. In other embodiments, the modules do not have the same dimensions one with respect to the other,

In some embodiments, a heat sink, which may be embodied by dissipation fins may be mounted on any sides or portions of the modular LIDAR system. Other cooling mechanisms could also be used to manage the thermal budget of the system, i.e., the heat dissipation fins could be replaced by any types of devices increasing the rate of heat transfer from the modular LIDAR system towards its environment.

In accordance with one aspect, there is provided a modular LIDAR system. The modular LIDAR system includes a plurality of modules and a two-level locking mechanism. The two-level locking mechanism is configured to mechanically engage two subsequent modules of the plurality of exchangeable modules. The two-level locking mechanism includes a first level and a second level.

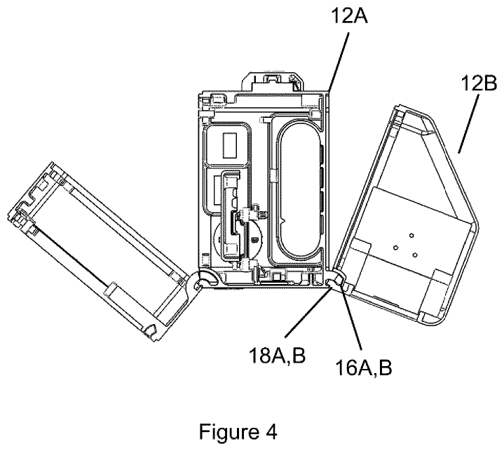

The first level is configured to align the two subsequent modules, i.e., the first level includes structural elements guiding or assisting the spatial orientation between the two modules. The first level includes a pair of sockets provided in one of the two subsequent modules and a pair of curved arms outwardly extending from another one of the two subsequent module. The sockets and curved arms are shaped and positioned to be engageable one with another, i.e., each curved arm is adapted to be inserted in a respective socket upon a relative rotational movement between the two subsequent modules. The shape of the sockets is complementary to the shape of curved arms. As illustrated in the cross-sectional view of FIG. 4, the curved arms each have a c-shaped profile. Similarly, the sockets each have an empty portion extending between an open end and a closed end. The empty portion has a c-shaped profile, compatible with the shape of the curved arms. The curved arms can be engaged in respective sockets through the open end and towards the closed end upon a relative rotational movement between the two subsequent modules, resulting in the two subsequent modules being aligned one with another.

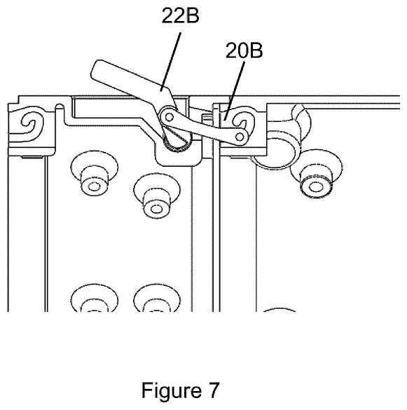

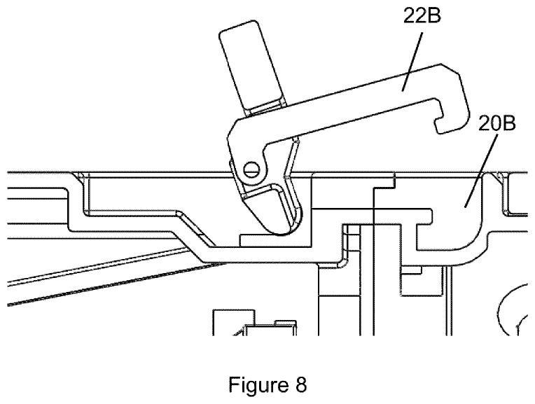

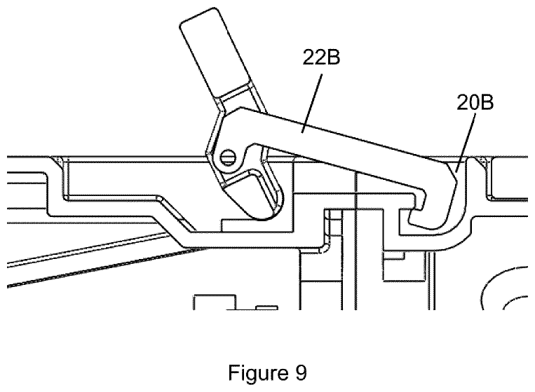

The second level is configured to lock the two subsequent modules together, after their relative alignment using the first level. The second level includes a pair of slots provided in one of the two subsequent modules and a pair of lever arms, each lever arm having a respective end outwardly extending from another one of the two subsequent module. Each lever arm is adapted to be inserted in a corresponding slot and lock the two subsequent modules together when a rotational movement is imparted to each lever arm. As illustrated in FIG. 7, the lever arm may include two segments mechanically connected one to the other using one or more pivots, such that when one of the two segments is engaged in a corresponding slot, the other one of the two segments can be pushed towards the modular LIDAR system to lock the two subsequent modules together.

In some embodiments, the modules include a main module, a LIDAR sensor, a photogrammetry camera, an inertial sensor module (IMU), a global positioning system (GPS), a processing unit, a data collection module, an external battery, an internal battery, a camera, a power supply, and/or any combinations thereof.

In some embodiments, at least one of the slots or sockets has a profiled or machined inner portion. For example, and without being limitative, the profiled or machine inner portion may include a textured or a tapered portion to facilitate the engagement with respective curved arm or lever arm. When the inner portion includes a tapered portion, the curved arms or lever arms may be squeezed or firmly pressed against the inner portion as the lever arm rotates.

In some embodiments, the two-level locking mechanism, including their respective components, may be made from a metal, a metallic material, or an alloy. In some embodiments, the two-level locking mechanism may be made from an aluminum alloy such as, for example and without being limitative, aluminum 6063. In some embodiments, only portion(s) of the two-level locking mechanism may be made from a metal, a metallic material, or an alloy.

In some embodiments, the plurality of exchangeable modules includes a main module, a LIDAR sensor, a photogrammetry camera, an inertial sensor module (sometimes referred to as “an inertial measuring unit” or an “IMU”, a global positioning system (GPS), a processing unit (sometimes referred to as a “computer” or “computing device”), a data collection module (sometimes referred to as a “memory”), an external battery, an internal battery, a camera, a power supply, and/or other modules. In some embodiments, the processing unit and the data collection may be integrated into a single device.

In some embodiments, the plurality of exchangeable modules is configured to be replaced or exchanged without recalibrating the modular LIDAR system.

In some embodiments, the plurality of exchangeable modules has standardized dimensions.

In some embodiments, at least one module is a processing unit configured to automatically determine which modules are present on the modular LIDAR system, and automatically select or adapt the operation settings of each module.

In some embodiments, the different operation settings are obtained from a calibration database. In some embodiments, the calibration database may be stored on a server. In some embodiments, the calibration database may be stored in the cloud.

### Example of an Implementation

In one implementation, the LIDAR sensor module may include the Puck 16 and 32 from Velodyne and the miniVUX 1UAV, 2UAV, and 1DL from RIEGL. The inertia measuring unit module may include the APX 15, 18, and 20 series from Applanix. The battery module capacity may be adapted depending on the LIDAR sensor module and may provide the option of incorporating an external power source. Optional Wi-Fi and RTK modules can be incorporated to improve the operation and performance.

Several alternative embodiments and examples have been described and illustrated herein. The embodiments described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. The present examples and embodiments, therefore, are to be considered in all respects as illustrative and not restrictive. Accordingly, while specific embodiments have been illustrated and described, numerous modifications come to mind without significantly departing from the scope defined in the current description and the appended claims.

1. A modular LIDAR system, comprising:
a plurality of modules; and
a two-level locking mechanism configured to mechanically engage two subsequent modules of said plurality of modules, the two-level locking mechanism comprising:
a first level configured to align the two subsequent modules, the first level comprising:
a pair of sockets provided in one of the two subsequent modules; and
a pair of curved arms outwardly extending from another one of the two subsequent module, wherein each curved arm is adapted to be inserted in a respective socket upon a relative rotational movement between the two subsequent modules; and
a second level configured to lock the two subsequent modules together, the second level comprising:
a pair of slots provided in one of the two subsequent modules; and
a pair of lever arms, each lever arm having a respective end outwardly extending from another one of the two subsequent module, wherein each lever arm is adapted to be inserted in a corresponding slot and lock the two subsequent modules together when a rotational movement is imparted to each lever arm.

2. The modular LIDAR system of claim 1, wherein said plurality of exchangeable modules comprises a main module, a LIDAR sensor, a photogrammetry camera, an inertial sensor module (IMU), a global positioning system (GPS), a processing unit, a data collection module, an external battery, an internal battery, a camera and/or a power supply.

3. The modular LIDAR system of claim 1, wherein said plurality of modules is configured to be replaced or exchanged without recalibrating the modular LIDAR system.

4. The modular LIDAR system of claim 1, wherein said plurality of modules has standardized dimensions.

5. The modular LIDAR system of claim 1, further comprising a cover.

6. The modular LIDAR system of claim 5, wherein the cover is made of rubber.

7. The modular LIDAR system of claim 1, wherein at least one of said plurality of modules is a processing module comprising a processor configured to:
automatically determine which modules are present on the modular LIDAR system; and
automatically select or adapt the operation settings of each module.

8. The modular LIDAR system of claim 7, wherein the operation settings are obtained from a calibration database.

9. The modular LIDAR system of claim 7, wherein the calibration database is stored on a server.

10. The modular LIDAR system of claim 7, wherein the calibration database is stored in the cloud.

11. The modular LIDAR system of claim 1, wherein each one of the pair of curved arms has an arm profile defining an arm circle arc.

12. The modular LIDAR system of claim 11, wherein the inner arm circle arc comprises a starting point and an ending point, separated by an angle of about 90°.

13. The modular LIDAR system of claim 1, wherein each one of the pair of sockets has a socket profile defining a socket circle arc.

14. The modular LIDAR system of claim 13, wherein the socket circle arc comprises a starting point and an ending point, separated by an angle of about 90°.

15. The modular LIDAR system of claim 1, wherein each one of the pair of lever arms comprises a proximal end and a distal end, the distal end comprising a hook-shaped portion adapted to be inserted the corresponding slot.

16. The modular LIDAR system of claim 1, wherein the modular LIDAR system comprises a top portion and a bottom portion, the two-level locking mechanism being provided in the bottom portion, the top portion comprising a second pair of slots provided in one of the two subsequent modules and a second pair of lever arms, each having a respective end outwardly extending from another one of the two subsequent module, the second pair of lever arms is adapted to be inserted in the second pair of slot sand lock the two subsequent modules together when a rotational movement is imparted to the second pair of lever arms.
